(19) United States
(12) Patent Application Publication
(10) Pub. No.: US 2010/0019013 A1
(43) Pub. Date: Jan. 28, 2010

(54) CUTTING STRIP, A CARTON INCLUDING A CUTTING STRIP AND A METHOD OF MAKING A CUTTING STRIP

(76) Inventor: Ian Jamie, Warwickshire (GB)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/375,083

(22) PCT Filed: Jul. 25, 2007
(86) PCT No.: PCT/GB2007/002843

§ 371 Date: Oct. 12, 2009

(30) Foreign Application Priority Data
Jul. 25, 2006 (GB) 0614773.0

(51) Int. Cl. B26F 3/02

(52) U.S. Cl. 225/91

(57) ABSTRACT

A serrated cutting strip (22) for a roll of clingfilm (20), foil or the like is made of compostable material such as polylactic acid.

The invention relates to a cutting strip, a carton including a cutting strip and a method of making a cutting strip.

During the last fifty years, the use of plastics has grown dramatically. A problem with this widespread use of plastics material is in relation to the environment. Plastics material, when placed in landfill, is persistent and may last for centuries. Certain polymers, such as PVC, can leach undesirable chemicals into the earth.

Metal also has a long intact duration in landfill, estimated at decades for steel and centuries for aluminum.

A carton for a roll of clingfilm, foil or the like commonly has a serrated cutting strip attached to the carton so that the serrated edge can be used to cut a sheet of clingfilm, foil or the like pulled from the roll within the carton. The carton is made of carton board, and the cutting strip may be made from aluminium or plastics material, namely polyethylene terephthalate, PET.

According to one aspect of the invention there is provided a serrated cutting strip for a carton for a roll of clingfilm, foil or the like, the strip being compostable.

As the strip is compostable, the landfill problem is solved, as the strip will literally turn to compost.

The strip may be compostable under industrial composting conditions and preferably is compostable in a domestic compost heap.

The strip is preferably compostable in less than twelve months under industrial composting conditions and suitably composts into carbon dioxide, water and humus.

In one embodiment, the strip is compostable in a domestic compost heap in the United Kingdom in less than one month, preferably less than one week.

The strip is preferably wholly or principally made of a material that can be consumed by microorganisms, such as bacteria, and/or fingi. The material may be wholly or principally made of a water soluble material.

According to another aspect of the invention there is provided a serrated cutting strip for a carton for a roll of clingfilm, foil or the like, the strip being wholly or principally made of a material that can be consumed by microorganisms, such as bacteria, and/or fungi.

According to another aspect of the invention there is provided a serrated cutting strip for a carton for a roll of clingfilm, foil or the like, the strip being wholly or pricipally made of a material that is water soluble.

Cutting strips made of plastics material are made from oil products. There are finite oil reserves and it is predicted that those reserves may be exhausted this century. The continuing manufacture of oil based plastics products therefore is not sustainable.

The composition of the strip preferably includes a polymer derived from plant matter.

According to a further aspect of the invention there is provided a serrated cutting strip for a carton for a roll of clingfilm, foil or the like, composition of the strip including a polymer derived from plant matter.

By using a polymer derived from plant matter, the source of the polymer material is sustainable.

Preferably the composition of the strip is principally a polymer derived from plant matter and may be wholly a polymer derived from plant matter. Where the composition of the strip includes other matter, such as plasticisers, additives or fillers, they are preferably also derived from plant matter and preferably also compostable.

Preferably the plant matter is from a plant in the group comprising maize, rice, sugar cane, sugar beet, wheat, potato, sweet potato and cassava. In a preferred embodiment the plant matter is from maize.

The polymer may be derived from starch and preferably is derived from a material with greater than 50% amylose, most preferably 70% amylose or greater.

The polymer may be a polyester. The polymer may be a hydroxy carboxylic acid polymer. The polymer may be a fatty acid polymer. The polymer may be at least one of the group comprising polylactic acid polymer, polyglycolic acid polymer, polyurethane and polyhydroxybutarate. Preferably the polymer is polylactic acid polymer.

The polymer may be a thermoplastic polymer.

The material from which the strip is made may have an impact strength of ≧40 kJ per m² and preferably ≧25 kJ per m².

The material from which the strip is made may have a tensile strength of ≧35 N per mm² 7ₚ40N per mm² and preferably has a tensile strength of ≧50 N per mm².

The strip may be 75 μm to 1500 μm in thickness, suitably 150 to 1200 μm, preferably 190 to 400 μm, preferably 195 to 350 μm, most preferably 200 to 300 μm.

The strip may be opaque or translucent but in a preferred embodiment the strip is transparent.

The strip is preferably suitable for direct food contact and may meet EU Plastics Directive 2002/72/EC.

The strip preferably has a low coefficient of friction. The dynamic coefficient of friction may be less than 0.25.

According to another aspect of the invention there is provided a carton including a cutting strip according to any of the preceding aspects of the invention and including any or none of the sub-features mentioned in relation thereto.

Preferably the carton is made of a compostable material. The carton may be wholly or principally made of a material that can be consumed by microorganisms, such as bacteria and/or fungi. The carton may be wholly or principally made of a water soluble material. The composition of the carton may include a polymer derived from plant matter. The carton may be made from the same material as the cutting strip and in that case the cutting strip may be integral with the carton. The carton may be made from carton board.

According to a further aspect of the invention there is provided a method of making a cutting strip for a carton for a roll of clingfilm, foil or the like, the method comprising the steps of fermentation of plant matter to lactic acid, polymerisation of the lactic acid to polylactic acid polymer in the form of a sheet and cutting the sheet to form the cutting strip.

An embodiment of the invention will now be described by way of example and with reference to the accompanying drawings, in which:

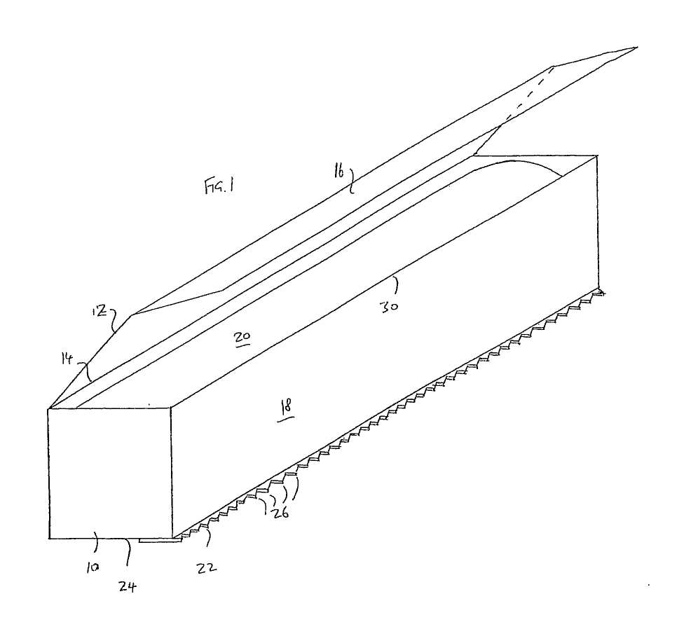

FIG. 1 is a perspective view of a clingfilm carton with a cutting strip of the embodiment of the invention;

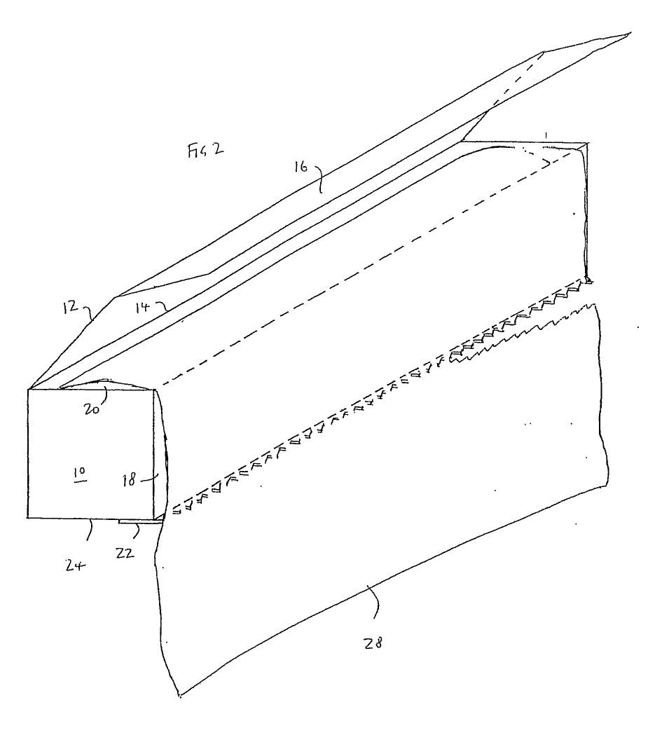

FIG. 2 is the view of FIG. 1 with a length of clingfilm pulled off the roll in the carton and being cut on the cutting strip; and,

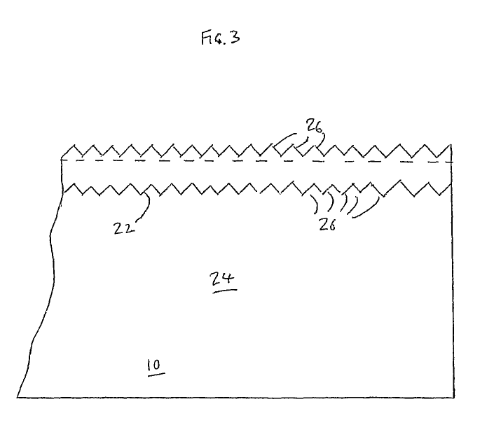

FIG. 3 is an underneath plan view of the carton of FIG. 1.

The carton 10 of the embodiment is an elongate rectangular carton which is square in side elevation. The carton 10 has a lid 12 hinged to the top of one long side wall through a fold 14 and at the opposite edge from the fold 14 is connected through a further fold to a flap 16. The flap 16 may be glued to the long front wall 18 of the carton 10. A roll of clingfilm 20 is received in the carton 10. The cutting strip 22 is attached to the underside 24 of the carton 10. The cutting strip 22 is elongate and has a series of cutting teeth 26 along each long edge. The cutting strip 22 is mounted such that the teeth 26 on one side of the cutting strip 22 project beyond the front wall 18 of the carton 10.

In use, a person detaches the flap 20 from the front wall 18 of the carton 10 and lifts the lid 12 to gain access to the roll of clingfilm 20. The user pulls the edge of the rolled clingfilm sheet 28 so that it comes out of the carton 10 and down the front wall 18 of the carton 10 to overlap the cutting teeth 26 of the cutting strip 22. By pulling the sheet 28 against the teeth 26, the teeth 26 of the cutting strip 22 can cut through the sheet 28 of clingfilm as shown in FIG. 2.

The carton 10 is made of carton board and the cutting strip 22 is a transparent polylactic acid (PLA) polymer film available from Folienwerk Wolfen GmbH using the NatureWorks (trade mark) resin from Cargill Dow LLC. The cutting strip 22 may be of 250 μm thickness and may be transparent. The cutting strip 22 made of this material is broken down under industrial composting conditions over the course of twelve months to result in carbon dioxide, water and humus. This is a two step degradation process. First, the moisture and heat in the compost pile attack the PLA polymer chains and split them apart creating smaller polymers, and finally, lactic acid. Microorganisms in the compost and soil consume the smaller polymer fragments and lactic acid as nutrients. Fungi and bacteria are involved in PLA degradation. The PLA polymer is derived from maize by fermentation to lactic acid followed by condensation and subsequent ring-opening polymerisation. Sheets formed of the polymer are cut to form the cutting strip 22. The impact strength of the material (4J pendulum) is about 40 kJ per m² and the tensile strength is about 50 N per mm₂.

When the clingfilm has been used up and the carton 10 is empty, the entire carton 10 with cutting strip 22 can be composted.

In another embodiment, the carton 10 may be made from the same material as the cutting strip 22 either in the same or a different thickness. Where the carton 10 is made of the same material as the cutting strip 22, the cutting strip 22 may be integral with the carton 10. The cutting strip 22 may in that case form the upper edge 30 of front wall 18 of the carton 10. The integral carton 10 and cutting strip 22 may be made of 300 μm thick plasticised PLA polymer.

For these embodiments, suitable PLA polymer is also available from Korea Fine Chemical Company.

A further embodiment is the same as the first embodiment described above with respect to FIGS. 1, 2 and 3, except that, as an alternative to PLA polymer, a starch-based bioplastic is used, such as the R1 (Trade Mark) polymer available from Plantic, Australia. This bioplastic is derived from maize starch having a high amylose content. The polymer cutting strip 22 may be 350 μm thick. The Plantic R1 material is compostable in a domestic compost heap in the United Kingdom in less than a week. The material is water soluble. The material can be translucent or transparent and may have an optical transparency of 89 to 93%. The tensile strength of the Plantic R1 material is about 42 to 46 MPa (ASTM D882 test method) and its static coefficient of friction is 0.215 and its dynamic coefficient of friction is 0.17.

The skilled person may be aware of other suitable bioplastics. The term “bioplastic” used herein is intended to refer to a polymer which is both derived from natural biological material, and is biodegradable.

1. A cutting strip for a carton for a roll of sheet material, wherein the cutting strip comprises teeth for cutting the sheet material, and the strip is compostable.

2. A cutting strip as claimed in claim 1, wherein the strip is cornpostable under industrial composting conditions.

3. A cutting strip as claimed in claim 2, wherein the strip is compostable in less than twelve months under industrial composting conditions.

4-6. (canceled)

7. A cutting strip as claimed in claim 1, wherein the strip is formed of a material that can be consumed by microorganisms in the form of bacteria or fungi.

8. A cutting strip for a carton for a roll of sheet material, wherein the cutting strip comprises teeth for cutting the sheet material and the strip is made of a material that can be consumed by microorganisms.

9. A cutting strip as claimed in claim 8, wherein the strip is made of a water soluble material.

10. (canceled)

11. A cutting strip as claimed in claim 8, wherein the composition of the strip includes a polymer derived from plant matter.

12-16. (canceled)

17. A cutting strip as claimed in claim 11, wherein the plant matter is from a plant in the group comprising maize, rice, sugar cane, sugar beet, wheat, potato, sweet potato and cassaya.

18. (canceled)

19. A cutting strip as claimed in claim 11, wherein the polymer is derived from starch.

20-21. (canceled)

22. A cutting strip as claimed in of claim 8, wherein the material includes a polyester.

23. A cutting strip as claimed in claim 8, wherein the material includes a hydroxy carboxylic acid polymer.

24. A cutting strip as claimed in claim 8, wherein the material includes a fatty acid polymer.

25. A cutting strip as claimed in claim 8, wherein the material includes at least one of the group comprising polylactic acid polymer, polyglycolic acid polymer, polyurethane and polyhydroxybutarate.

26. (canceled)

27. A cutting strip as claimed in claim 8, wherein the material includes a thermoplastic polymer.

28-42. (canceled)

43. The serrated cutting strip of claim 8, wherein the cutting strip is attached to a carton, and wherein the carton is wholly or principally made of a material that can be consumed by microorganisms.

44-49. (canceled)

50. The cutting strip of claim 1, wherein the cutting strip is serrated.

51. The cutting strip of claim 8, wherein the cutting strip is serrated.
